(19) United States
(12) Patent Application Publication
(10) Pub. No.: US 2012/0212671 A1
(43) Pub. Date: Aug. 23, 2012

(54) AUDIO-VISUAL SYSTEM AND METHOD FOR VIDEO CONTENT PLAYBACK THEREOF

(75) Inventor: JUI-LIN GUO, Tu-Cheng (TW)

(73) Assignee: HON HAI PRECISION INDUSTRY CO., LTD., Tu-Cheng (TW)

(21) Appl. No.: 13/398,708

(22) Filed: Feb. 16, 2012

(30) Foreign Application Priority Data
Feb. 21, 2011 (CN) 201110042317.8

(51) Int. Cl. H04N 9/475; H04N 5/06

(52) U.S. Cl. 348/513; 348/521; 348/E09.034; 348/E05.011

(57) ABSTRACT

A set top box (STB), which communicates with a display device and a number of audio-visual apparatuses, comprises one or more media processors, a video multiplexer, an audio multiplexer, and a transmitting module. The media processors receive a number of program channels selected by a number of users and identities corresponding to the audio-visual apparatuses, and demodulate the program channels into video streams and corresponding audio streams. The video multiplexer composes the video streams into an integrated video stream and the audio multiplexer composes the audio streams into an integrated audio stream. The STB transmits the integrated video stream and the integrated audio stream to the audio-visual apparatuses.

### BACKGROUND

1. Technical Field

Embodiments of the present disclosure relate to audio-visual systems, and more particularly to an audio-visual system and a method for video content playback thereof.

2. Description of Related Art

Many families have more than one television at home, so that various family members can satisfy their own viewing preferences. However, families might better enjoy themselves if all members could be together in the same room to watch TV. Accordingly, it would be desirable to all members of family to view their preferred programs at the same time using only one television.

### BRIEF DESCRIPTION OF THE DRAWINGS

FIG. 1 is a schematic diagram of one embodiment of an audio-visual system as disclosed.

FIG. 2 is a block diagram of one embodiment of a set top box of the audio-visual system.

FIG. 3 is a schematic diagram of one embodiment of a temporal relationship between an integrated video stream and synchronization signals.

FIG. 4 is a schematic diagram of one embodiment of a format of an audio packet of an integrated audio stream.

FIG. 5 is a block diagram of one embodiment of an audio-visual apparatus.

FIG. 6 is a flowchart of one embodiment of a method of simultaneous playback of different video content for a plurality of users.

### DETAILED DESCRIPTION

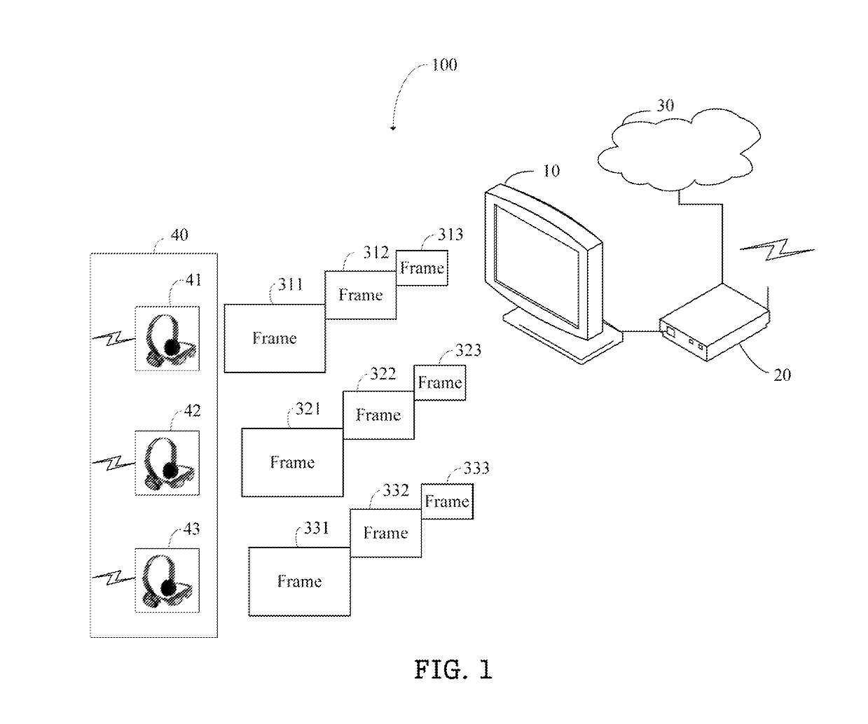

FIG. 1 is a block diagram of one embodiment of an audio-visual system 100. In one embodiment, the system 100 may includes a display apparatus 10, a set top box (STB) 20, and a plurality of audio-visual(A/V) apparatuses 40. The display apparatus 10 and the STB 20 serve as A/V apparatuses interacting with the A/V apparatuses 40. The STB 20 receives MPEG transport streams in which a plurality of program channels are multiplexed from the Internet 30 and outputs program channels selected by a plurality of users on the display apparatus 10. The users use the A/V apparatuses 40 to view respective preferred program channels on the display apparatus 10.

As shown in FIG. 1, for example, a first user selects a first program channel via a first remote control which is represented by a sequence of video frames 311, 312, and 313, a second user selects a second program channel via a second remote control which is represented by a sequence of video frames 321, 322, and 323, and a third user selects a third program channel via a third remote control which is represented by a sequence of video frames 331, 332, and 333. The display apparatus 10 displays sequences of frames in turn, and the three users use respective audio-visual apparatuses 41, 42, and 43, such as a glasses-type media player, to view respective selected program channels.

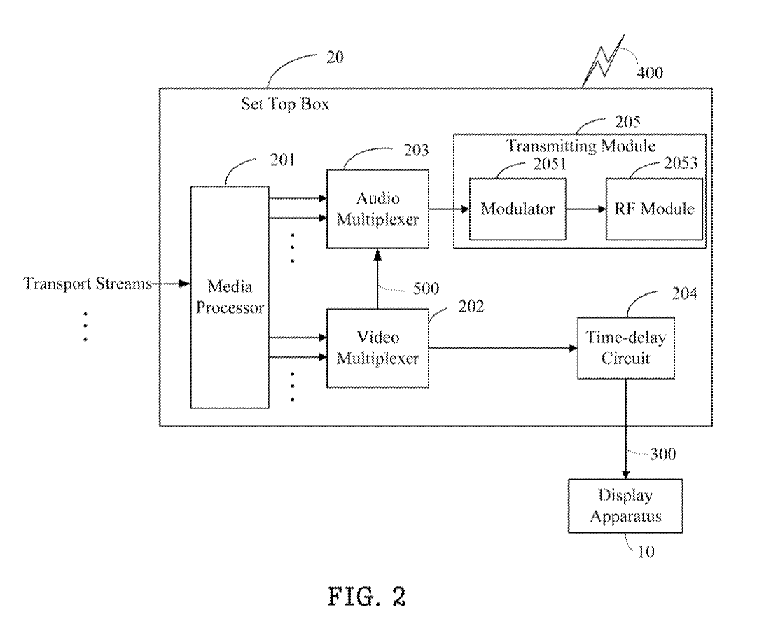

FIG. 2 is a block diagram of one embodiment of the STB 20 of the system 100. In one embodiment, the STB 20 may comprise one or more media processors 201, a video multiplexer 202, an audio multiplexer 203, a time-delay circuit 204, and a transmitting module 205. The one or more media processors 201 may include a general processor, a digital signal processor, an application specific integrated circuit (ASIC), a field programmable gate array (FPGA), an analog circuit, a digital circuit, or combinations thereof. In one embodiment, the transmitting module 205 includes a modulator 2051 and a radio frequency (RF) module 2053.

After the STB 20 receives particular program channel selections from users, the media processor 201 receives corresponding MPEG transport streams from the Internet 30. For example, the first user selects program channel number 10, the second user selects program channel number 30, and the third user selects program channel number 50, and the media processor 201 receives MPEG transport stream containing program channel numbers 10, 30, and 50. In one embodiment, the STB 20 receives particular program channel selections and identifiers of the A/V apparatuses 40 at the same time.

Each program channel comprises video stream and audio stream accompanying the video stream, and the video stream comprises a sequence of frames. In one embodiment, the one or more media processors 201 extract a plurality of video streams and a plurality of audio streams accompanying the plurality of video streams from the selected program channels, and transmit the plurality of video streams to the video multiplexer 202 and the plurality of audio streams to the audio multiplexer 203.

The video multiplexer 202 receives and reprocesses the plurality of video streams into an integrated video stream 300 by reordering frame sequence according to a receiving order of users' selected program channels. For example, the first user selects the first program channel video stream of which comprises the sequence of frames 311, 312 and 313, the second user selects the second program channel video stream of which comprises the sequence of frames 321, 322 and 323, and the third user selects the third program channel video stream of which comprises the sequence of frames 331, 332 and 333. The video multiplexer 202 processes the received video streams into the integrated video stream 300 combining the frames into a sequence of 311, 321, 331, 312, 322, 332, 313, 323, and 333. Then the video multiplexer 202 outputs the integrated video stream 300 to the display apparatus 10 via the time-delay circuit 204.

In one embodiment, the audio multiplexer 203 receives the plurality of audio streams, processes the plurality of audio streams into an integrated audio stream 400 and transmits the integrated audio stream 400 to the A/V apparatuses 40 through the transmitting module 205. Further details of processing the audio streams are described in the following. In one embodiment, the time-delay circuit 204 delays output of the integrated video stream 300 to the display apparatus 10 for a predetermined time period T1, to synchronize the integrated video stream 300 with the integrated audio stream 400 received at the A/V apparatuses 40.

In one embodiment, the video multiplexer 202 outputs one synchronization signal for each video frame of the integrated video stream 300 during output of the frame to the time-delay circuit 204. Duration of the synchronization signal is substantially equal to playback time of the frame associated with the synchronization signal on the display apparatus 10. In the case of their being three selected channels, for example, the video multiplexer 202 outputs a first synchronization signal in synchronization with a first frame of the integrated video stream 300 associated with a first selected channel, a second synchronization signal in synchronization with a second frame of the integrated video stream 300 associated with a second selected channel, and a third synchronization signal in synchronization with a third frame of the integrated video stream 300 associated with a third selected channel.

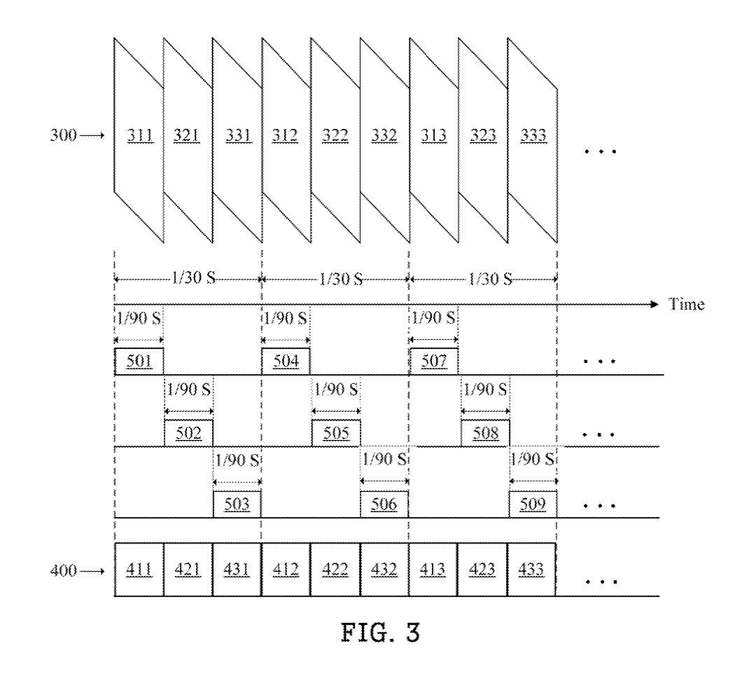

FIG. 3 is a schematic diagram of one embodiment of a temporal relationship between the integrated video stream 300 and synchronization signals 501-509. In general, the display apparatus 10 displays at least 30 video frames per second (fps) to ensure the human sees smooth video playback. However, when there is more than one user viewing respective preferred program channels displayed on the display apparatus 10, the number of fps should be increased according to the number of users. For example, if there are totally three users viewing respective preferred program channels, the display apparatus 10 should display at 90 fps. In other words, each frame of the integrated video frame 300 is displayed on the display apparatus 10 for 1/90 second.

As shown in FIG. 3, the video multiplexer 202 outputs the frame 311 at the first 1/90 second and simultaneously generates the synchronization signal 501 for 1/90 second, outputs the frame 321 at the second 1/90 second and simultaneously generates the synchronization signal 502 for 1/90 second, outputs the frame 331 at the third 1/90 second and simultaneously generates the synchronization signal 503 for 1/90 second, and so on. In one embodiment, the video multiplexer 202 outputs the generated synchronization signals 501-509 to the audio multiplexer 203. The audio multiplexer 203 constructs audio packets of the integrated audio stream 400 using the time period of the received synchronization signals 501-509, audio signals corresponding to respective frames of the integrated video stream 300, and identifiers of the A/V apparatuses 40, e.g., MAC addresses.

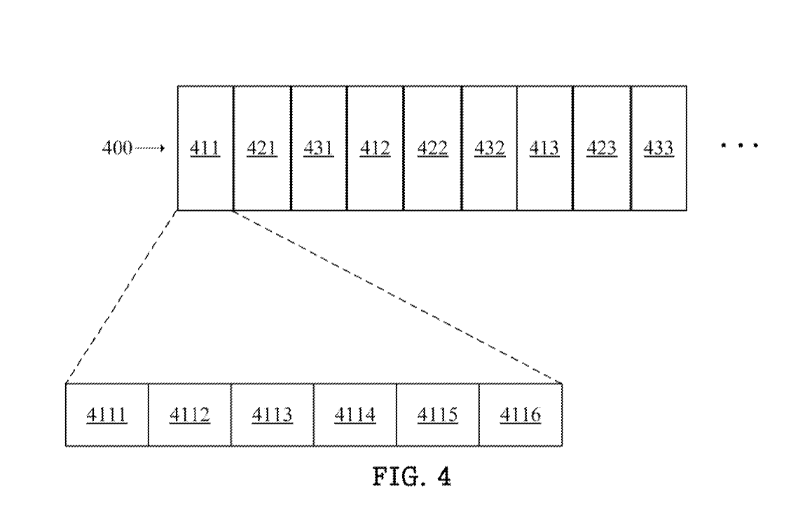

Specifically, as shown in FIG. 3, since each frame of the integrated video frame 300 is displayed on the display apparatus 10 for 1/90 second, therefore the length of each audio packet of the integrated audio stream should be 1/90 second for synchronization with the video. For example, the audio multiplexer 203 constructs a first audio packet 411 based on the time period of the synchronization signal 501, audio signals corresponding to the video frame 311, and identifier of the audio-visual apparatus 41 at the first 1/90 second, constructs a second audio packet 421 based on the time period of the synchronization signal 502, audio signals corresponding to the video frame 321, and identifier of the audio-visual apparatus 42 at the second 1/90 second, constructs a third audio packet 431 based on the time period of the synchronization signal 503, audio signals corresponding to the video frame 331, and identifier of the audio-visual apparatus 43 at the third 1/90 second, and so on. The audio multiplexer 203 outputs the integrated audio stream 400 composed of the audio packets 411, 421, 431 412, 422, 432, 413, 423 and 433 according to the order of the synchronization signals 501-509. Specific format of each audio packet of the integrated audio stream 400 is shown in FIG. 4.

FIG. 4 is a schematic diagram of one embodiment of a format of the audio packet 411 of the integrated audio stream 400. The audio packet 411 comprises a user identifier field 4111, a synchronization width field 4112, an audio size field 4113, a left audio channel field 4114, a right audio channel field 4115, and a checksum field 4116. The user identifier field 4111 indicates identifier of one of the A/V apparatuses 40. The synchronization width field 4112 indicates time period of a synchronization signal. The audio size field 4113 indicates length of an audio signal. The left audio channel field 4114 stores audio signals for a left audio channel. The right audio channel field 4115 stores audio signals for a right audio channel. The checksum field 4116 stores a checksum of the audio packet 411.

Returning to FIG. 2, the STB 20 uses the transmitting module 205 to transmit the integrated audio stream 400 to the A/V apparatuses 40. The demodulator 2051 translates the integrated audio stream 400 into low-frequency analog signals. The RF module 2053 translates the low-frequency analog signals into high-frequency analog signal and transmits to the A/V apparatuses 40.

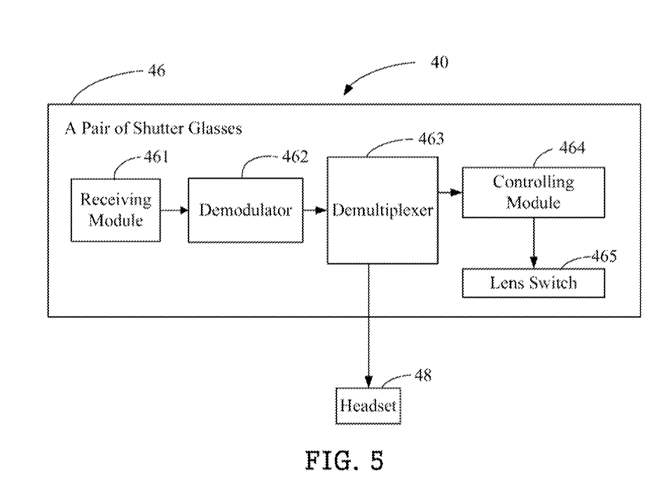

FIG. 5 is a block diagram of one embodiment of the A/V apparatuses 40. The A/V apparatuses 40 are divided into several groups according to number of users, and each group comprises a pair of shutter glasses 46, and a headset 48. The pair of shutter glasses 46 comprises a receiving module 461, a demodulator 462, a demultiplexer 463, a controlling module 464, and a lens switch 465. In one embodiment, the pair of shutter glasses 46 stores identifier of the A/V apparatus 40. The controlling module 464 controls on/off of lenses of the pair of shutter glasses 46 by the lens switch 465 according to duration of the synchronization signals 501-509. If the lens switch 465 is on, one user can view frames displaying on the display apparatus 10, otherwise, if the lens switch 465 is off, the user cannot view frames displaying on the display apparatus 10.

The receiving module 461 receives the integrated audio stream 400 from the STB 20. The demodulator 462 and the demultiplexer 463 demodulate and demultiplex audio packets of the integrated audio stream 400 to obtain information contained in the user identifier field 4111, the synchronization width field 4112, the audio size field 4113, the left audio channel field 4114, the right audio channel field 4115 and the checksum field 4116. The demultiplexer 463 further compares the user identifier of an audio packet with the identifier stored in the pair of shutter glasses 46.

If the user identifier of the audio packet is equal to the identifier stored in the pair of shutter glasses 46, the demultiplexer 463 notifies the controlling module 464 to switch on the lens switch 465 for a time period according to a duration of a synchronization signal in the synchronization width field 4112, and outputs audio signals stored in the left audio channel field 4114 and the right audio channel field 4115 to the headset 48. Otherwise, if the user identifier of the audio packet is not equal to the identifier stored in the pair of shutter glasses 46, the demultiplexer 463 notifies the controlling module 464 to switch off the lens switch 465 for a time period according to a duration of a synchronization signal in the synchronization width field 4112. In one embodiment, the controlling module 464 outputs square wave digital signals to control the lens switch 465. Thus, the controlling module 464 may use high-level signal to switch on the lens switch 465 and low-level signal to switch off the lens switch 465.

In one embodiment, T21 represents a time period beginning from reception of the integrated audio stream 400 by the modulator 2051 and ending at output of the modulated integrated audio stream 400 by the modulator 2051 to the RF module 2053, T22 represents a time period beginning from transmission of the integrated audio stream 400 by the RF module 2053 and ending at reception of the integrated audio stream 400 by the receiving module 461, and T23 represents a time period beginning from reception of the integrated audio stream 400 at the demodulator 462 and ending at output corresponding audio signals of the integrated audio stream 400 by the demultiplexer 463. In order to achieve audio-video synchronization, the predetermined delay time T1 used by the time-delay circuit 204 should be equal to sum of T21, T22, and T23.

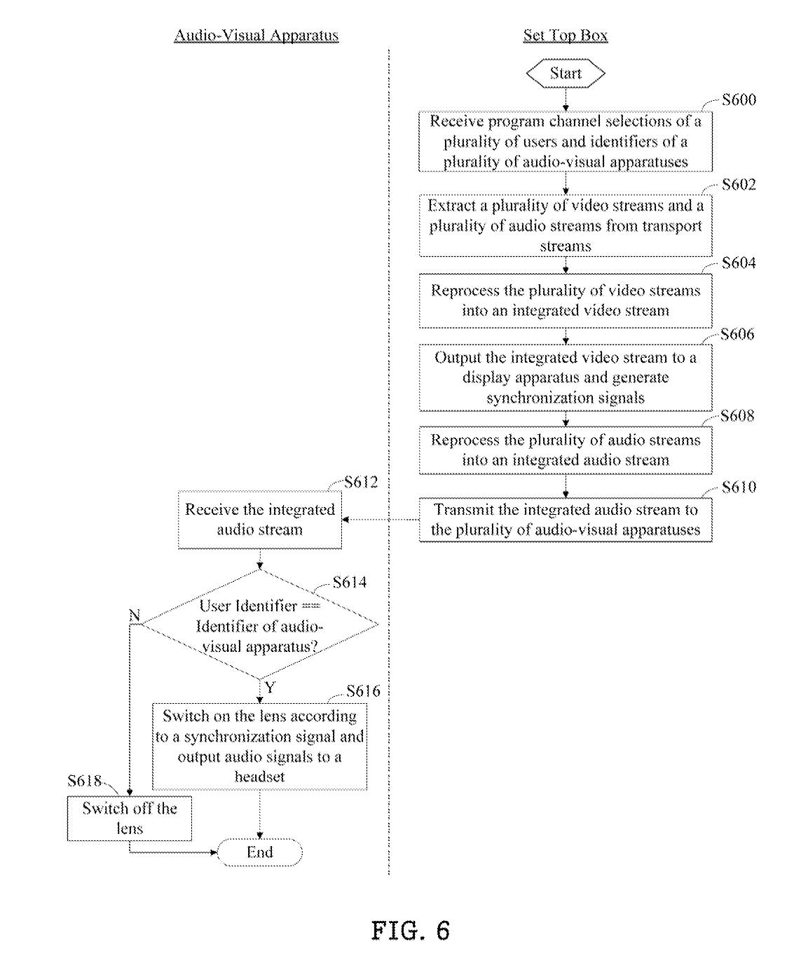

FIG. 6 is a flowchart of one embodiment of a method of simultaneous playback of different video contents for a plurality of users. The progression of the method may be controlled automatically by the STB 20 and the A/V apparatuses 40.

In step S600, the STB 20 receives respective program channel selections from a plurality of users and identifiers of the A/V apparatuses 40, and proceeds to step S602. After receiving MPEG transport streams, the STB 20 extracts a plurality of video streams and a plurality of audio streams from users selected program channels in step S602. For example, three users, named “A”, “B” and “C”, select program channel numbers 10, 30 and 50 respectively. The one or more media processors 201 of the STB 20 then extract a plurality of video streams and a plurality of audio streams of the program channel numbers 10, 30, and 50 from MPEG transport streams, output the plurality of video streams to the video multiplexer 202 and output the plurality of audio streams to the audio multiplexer 203. In step S604, the video multiplexer 202 receives and processes the plurality of video streams into an integrated video stream 300 by reordering sequences of frames of the plurality of video streams according to receiving order of users selected program channels. For example, the video stream of the program channel number 10 comprises a sequence of frames such as frames 311, 312, and 313, the video stream of the program channel number 30 comprises a sequence of frames such as frames 321, 322, and 323, and the video stream of the program channel number 50 comprises a sequence of frames such as frames 331, 332, and 333. The video multiplexer 202 processes received video streams into a integrated stream 300 comprising a combined sequence of the frames such as 311, 321, 331, 312, 322, 332, 331, 332, and 333. In step S606, the video multiplexer 202 outputs the combined sequence of frames of the video stream 300 to the display apparatus 10 through the time-delay circuit 204. The video multiplexer 202 generates and outputs one synchronization signal, such as the synchronization signals 501-509, to the audio multiplexer 203 while outputting one frame of the integrated video stream 300 to the time-delay circuit 204. The time period of the synchronization signals 501-509 is matched with duration of display of the corresponding frame on the display apparatus 10. In one embodiment, the integrated video stream 300 is delayed for a predetermined time period, T1, by the time-delay circuit 204 before output to the display apparatus 10. In step S608, the audio multiplexer 203 uses the time period of the synchronization signals 501-509, audio signals in the plurality of audio streams, and identifiers of the A/V apparatuses 40 to construct audio packets of the integrated audio stream 400. For example, the audio multiplexer 203 constructs a first audio packet 411 with the time period of the synchronization signal 501, audio signal corresponding to the video frame 311, and identifier of the A/V apparatus 40 which user “A” uses at the first 1/90 second, constructs a second audio packet 421 with the time period of the synchronization signal 502, audio signal corresponding to the video frame 321, and identifier of the A/V apparatus 40 which user “B” uses at the second 1/90 second, constructs a third audio packet 431 with the time period of the synchronization signal 503, audio signal corresponding to the video frame 331, and identifier of the A/V apparatus 40 which the third user uses at the third 1/90 second, and so on. In step S610, the STB 20 transmits the integrated audio stream 400 to the A/V apparatuses 40.

In step S612, the pair of shutter glasses 46 of the A/V apparatus 40 receives the integrated audio stream 400 from the STB 20. Then the demodulator 462 and the demultiplexer 463 respectively demodulate and demultiplex audio packets of the integrated audio stream 400 to obtain information in the user identifier field 4111, the synchronization width field 4112, the audio size field 4113, the left audio channel field 4114, the right audio channel field 4115, and the checksum field 4116. In Step S614, the demultiplexer 463 further compares the user identifier of an audio packet with the identifier stored in the pair of shutter glasses 46. If the user identifier of the audio packet is equal to the identifier stored in the pair of shutter glasses 46, in step S616, the demultiplexer 463 notifies the controlling module 464 to switch on the lens switch 465 for a time period according to a time period in the synchronization width field 4112, and outputs audio signals in the left audio channel field 4114 and the right audio channel field 4115 to the headset 48. Otherwise, if the user identifier of the audio packet isn't equal to the identifier stored in the pair of shutter glasses 46, in step S618, the demultiplexer 463 notifies the controlling module 464 to switch off the lens switch 465 for a time period according to time period in the synchronization width field 4112.

In conclusion, the STB 20 and the A/V apparatuses 40 provide a method of a simultaneous playback of different video contents for a plurality of users. The STB 20 outputs user selected program channels to the display apparatus 10, and the plurality of users use the A/V apparatuses 40 to view respective selected program channels.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the disclosure is to be defined only by the claims appended hereto and their equivalents.

What is claimed is:

1. An audio-visual system operable to deliver media streams to a plurality of audio-visual apparatuses, comprising:
one or more media processors operable to receive program channel selections from a plurality of remote controls, transport streams corresponding to program channels selected in the program channel selections from a network, and identifiers of the plurality of audio-visual apparatuses, and extract a first video stream of a first channel in the selected program channels and a second video stream of a second channel in the selected program channels from the transport streams;
a video multiplexer operable to generate an integrated video stream from video frames of the first video stream and the second video stream, wherein a first video frame of the integrated video stream comprises a first video frame of the first video stream and a first synchronization signal in synchronization with the first video frame of the first video stream, and a second video frame of the integrated video stream comprises a second video frame of the second video stream and a second synchronization signal in synchronization with the second video frame of the second video stream.

2. The audio-visual system of claim 1, further comprising:
an audio multiplexer operable to generate an integrated audio stream in synchronization with the integrated video stream from a first audio stream of the first channel and a second audio stream of the second channel using the first and second synchronization signals and the identifiers of the plurality of audio-visual apparatuses.

3. The audio-visual system of claim 2, further comprising:
a transmitting module operable to transmit the integrated audio stream to the plurality of audio-visual apparatuses.

4. The audio-visual system of claim 1, further comprising:
a time-delay circuit operable to delay the integrated video stream for a predetermined time.

5. The audio-visual system of claim 1, wherein duration of the first synchronization signal is matched with duration of display of the first frame of the integrated video stream.

6. The audio-visual system of claim 1, wherein each group of the plurality of audio-visual apparatuses comprises:
a headset; and
a pair of shutter glasses operable to store an identifier of the audio-visual apparatus.

7. The audio-visual system of claim 6, wherein the pair of shutter glasses further comprises:
a receiving module to receive the integrated audio stream consists of a sequence of audio packets, wherein each audio packet comprises a user identifier field and a synchronization width field;
a lens switch; and
a controlling module to switch on the lens switch and output audio signals containing in the integrated audio stream if a value of the user identifier field is equal to the identifier stored in the pair of shutter glasses.

8. The audio-visual system of claim 7, wherein if the value of the user identifier field is not equal to the identifier stored in the pair of shutter glasses, the controlling module switches off the lens switch.

9. A method of video content playback executed in an audio-visual system operable to deliver media streams to a plurality of audio-visual apparatuses, comprising:
receiving program channel selections from a plurality of remote controls, transport streams corresponding to program channels selected in the program channel selections from a network, and identifiers of the plurality of audio-visual apparatuses, extracting a first video stream of a first channel in the selected program channels and a second video stream of a second channel in the selected program channels from the transport streams;
generating an integrated video stream from video frames of the first video stream and the second video stream, wherein a first frame of the integrated video frame comprises a first video frame of the first video stream and a first synchronization signal in synchronization with the first video frame of the first video stream, and a second video frame of the integrated video stream comprises a second video frame of the second video stream and a second synchronization signal in synchronization with the second video frame of the second video stream.

10. The method of video content playback of claim 9, further comprising:
generating an integrated audio stream in synchronization with the integrated video stream from a first audio stream of the first channel and a second audio stream of the second channel using the first and second synchronization signals and the identifiers of the plurality of audio-visual apparatuses.

11. The method of video content playback of claim 10, further comprising:
transmitting the integrated audio stream to the plurality of the audio-visual apparatuses.

12. The method of video content playback of claim 9, wherein duration of the first synchronization signal is matched with duration of display of the first frame of the integrated video stream.

13. The method of video content playback of claim 10, wherein each group of the plurality of audio-visual apparatuses comprising a headset and a pair of shutter glasses, further comprises:
the pair of shutter glasses storing an identifier of the audio-visual apparatus and receiving the integrated audio stream consists of a sequence of audio packets, wherein each audio packet comprises a user identifier field and a synchronization width field.

14. The method of video content playback of claim 13, further comprising:
the pair of shutter glasses switching on lens of the pair of shutter glasses if a value of the user identifier field is equal to the stored identifier,

15. The method of video content playback of claim 14, further comprising:
the pair of shutter glasses switching off lens of the pair of shutter glasses if the value of the user identifier field is not equal to the stored identifier.
